(19) United States
(12) Patent Application Publication
(10) Pub. No.: US 2010/0255290 A1
(43) Pub. Date: Oct. 7, 2010

(54) Carbon nanotube metal nanoparticle composite and method for making the same

(75) Inventors: Yao-Wen Bai, Beijing (CN); Qiu-Yue Zhang, Shenzhen City (CN); Cheng-Hsien Lin, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignees: Tsinghua University, Beijing (CN); HON HAI PRECISION INDUSTRY CO., LTD., Tu-Cheng (TW)

(21) Appl. No.: 12/589,477

(22) Filed: Oct. 22, 2009

(30) Foreign Application Priority Data
Apr. 7, 2009 (CN) 200910106566.1

(51) Int. Cl. B32B 5/16; C01B 31/00; B01J 19/12

(52) U.S. Cl. 428/327; 204/157.47; 204/157.41; 977/742

(57) ABSTRACT

A method for making carbon nanotube precious metal nanoparticles composite includes the following steps. A solution dissolving precious metal ions is provided. A water soluble polymer is provided and dissolved in water to form a solution of the soluble polymer. The solution of the precious metal ions is added into the solution of the soluble polymer to form a first mixture. A solution of carbon nanotubes is provided and added in the first mixture to form a second mixture. The second mixture is irradiated via radiation, the radiation have a wave length less than 450 nm.

### RELATED APPLICATIONS

This application is related to commonly-assigned applications entitled, “INKJET INK AND METHOD FOR MAKING CONDUCTIVE WIRES USING THE SAME”, filed **** (Atty. Docket No. US23065) and “METHOD FOR MAKING CONDUCTIVE WIRES”, filed **** (Atty. Docket No. US21886).

### BACKGROUND

1. Technical Field

The present disclosure relates to a carbon nanotube composite and methods for making the same, and particularly, to a carbon nanotube metal nanoparticle composite and method for making the same.

2. Description of Related Art

The discovery of carbon nanotubes has stimulated a great amount of research efforts around the world. Carbon nanotubes are characterized by the near perfect cylindrical structures of seamless graphite. They have been predicted to possess unusual mechanical, electrical, magnetic, catalytic, and capillary properties. A wide range of potential applications has been suggested including uses as one-dimensional conductors for the design of nanoelectronic devices, as reinforcing fibers in polymeric and carbon composite materials, as absorption materials for gases such as hydrogen, and as field emission sources.

In recent years, carbon nanotube metal nanoparticle composite has become a hot subject of research. Carbon nanotubes have become ideal carrier materials for fuel cells because of their large surface areas and high electric conductivity. In addition, the large surface areas and high electric conductivity make the carbon nanotubes ideal supporting materials for metal nanoparticles (NPs) catalysts such as Pt and Pd NPs, which have shown great promise for use in electrochemical cells and fuel cells.

A method for making a carbon nanotube metal nanoparticle composite is disclosed in a publication, “Growth of Pb, Pt, Ag and Au Nanoparticles on Carbon Nanotubes,” Bin Xue et al. J. Mater. Chem., 11 (9), 2378-2381, 2001. By thermal decomposition of metal salts, palladium, platinum, silver and gold nanoparticles, with an average size of 7 nm, 8 nm, 17 nm and 8 nm, respectively, were grown on carbon nanotubes. In this publication, the carbon nanotube metal nanoparticle composite is in a solid state which limits its application.

Another method for making a carbon nanotube metal nanoparticle composite is disclosed in a paper, “Templated Synthesis of Single-Walled Carbon Nanotube and Metal Nanoparticle Assemblies in Solution”, Dan Wang et al., J. AM. CHEM. SOC., 128, 15078-15079, 2006″.

The method provided by Dan Wang et al. includes the following steps. Single-Walled Carbon Nanotubes (SWNTs) are first individually dispersed in aqueous solutions in a poly(styrene-alt-maleic acid) (PSMA) surfactant. The SWNTs are combined with the SWNTs in the solutions. A solvent of Pt(thery)Cl₂ is added into the solutions and the Pt ions are combined with the PSMA to form a complex. The metal ions are chemically reduced by adding a NaBH₄ solvent into the solutions. The NaBH₄ solvent must be used to reduce the Pt ions because PSMA has a poor reduction characteristic, which makes the method more complicated.

What is needed, therefore, is to provide a carbon nanotube metal nanoparticle composite and method for making the same.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments.

FIG. 1 is a schematic view of one embodiment of the carbon nanotube metal nanoparticle composite.

FIG. 2 is a Scanning Electron Microscope image of one embodiment of the carbon nanotube metal nanoparticle composite.

FIGS. 3A to 3D are schematic views of steps of one embodiment of a method for making carbon nanotube metal nanoparticle composite.

FIGS. 4A to 4E are schematic views of steps of another embodiment of a method for making carbon nanotube metal nanoparticle composite.

### DETAILED DESCRIPTION

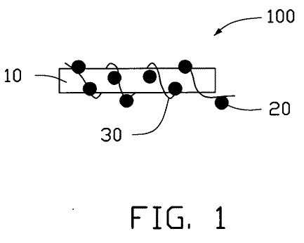

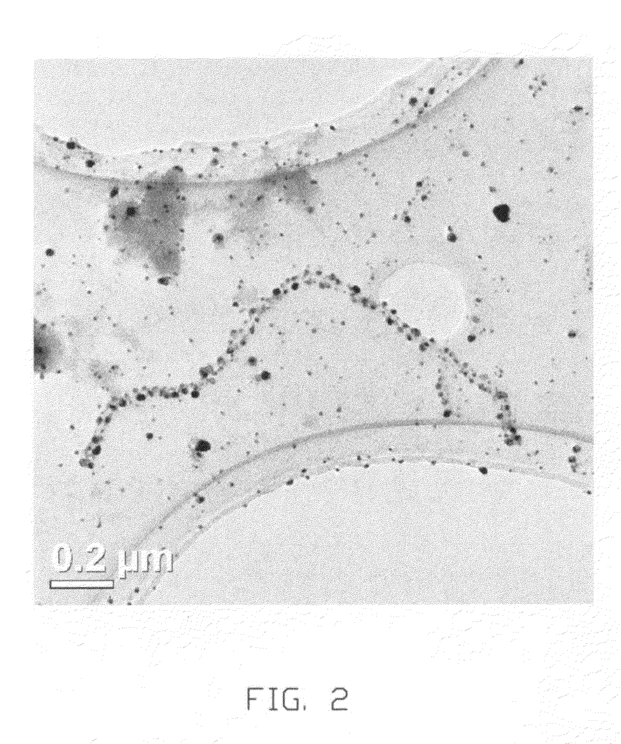

Referring to FIG. 1 and FIG. 2, the present disclosure provides a carbon nanotube metal nanoparticle composite 100. The carbon nanotube metal nanoparticle composite 100 includes carbon nanotubes 10, water soluble polymer 30, and precious metal nanoparticles 20. At least one water soluble polymer 30 is entangled on a surface of each of the carbon nanotubes 10, and precious metal nanoparticles 20 are attached to the water soluble polymer 30. As a result, the precious metal nanoparticles 20 are attached on the surface of each of the carbon nanotubes 10 via the water soluble polymer 30.

The carbon nanotubes 10 can be single-walled carbon nanotubes, double-walled carbon nanotubes, multi-walled carbon nanotubes or combinations thereof. A diameter of each of the carbon nanotubes 10 can be less than about 50 nanometers. A length of each of the carbon nanotubes 10 can be less than about 2 micrometers. In the present embodiment, the diameter of each of the carbon nanotubes 10 is less than about 50 nanometers, and the length of the carbon nanotubes 10 is in a range from about 50 nanometers to about 200 nanometers.

Furthermore, the carbon nanotubes 10 can be chemically functionalized, which refers to carbon nanotubes 10 being chemically treated to introduce functional groups on the surface. Chemical treatments include, but are not limited to, oxidation, radical initiation reactions, and Diels-Alder reactions. The functional groups can be any hydrophilic group, such as carboxyl (—COOH), aldehyde group (—CHO), amidogen group (—NH₂), hydroxyl (—OH) or combinations thereof. The carbon nanotubes 10 are soluble in the solvent by the provision of the functional groups.

The precious metal nanoparticles 20 can be made of gold (Au), silver (Ag), palladium (Pd), or platinum (Pt). The precious metal nanoparticles 20 are sized in a range from about 1 nm to about 20 nm. The precious metal nanoparticles 20 can be precious metal atoms. The precious metal atoms are adhered on the surface of each of the carbon nanotubes 10. In one embodiment, the precious metal nanoparticles 20 are Ag atoms.

The water soluble polymer 30 can be a polymer having carbonyl or hydroxyl, such as polyvinyl pyrrolidones (PVP), polyvinyl alcohols (PVA), polyethyleneimines (PEI), or combinations thereof. In one embodiment, the water soluble polymer 30 is PVP.

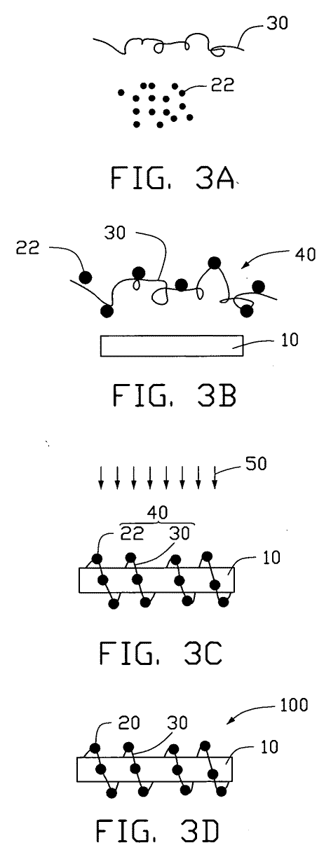

Referring to FIGS. 3A to 3D, one embodiment of a method for making a carbon nanotube metal nanoparticle composite 100 includes:

(S10) providing a solution containing precious metal ions 22;

(S20) providing a water soluble polymer 30 with carbonyl or hydroxyl, and dissolving the soluble polymer 30 in water to form a solution of the soluble polymer 30;

(S30) mixing the solution of the precious metal ions 22 with the solution of the soluble polymer 30 to form a first mixture;

(S40) providing a solution containing carbon nanotubes 10, and mixing the solution of carbon nanotubes 10 with the first mixture to form a second mixture;

(S50) irradiating the second mixture with radiation from a radiation source 50 having a wavelength less than 450 nm.

In step (S10), the precious metal ions 22 can be gold ions (Au⁺), silver ions (Ag⁺), palladium ions (Pd⁺), or platinum ions (Pt⁺). In one embodiment, the precious ions are Ag⁺. Silver nitrate can be directly dissolved in water to obtain the solution with silver ions.

In step (S20), the water soluble polymer 30 with carbonyl or hydroxyl can be polyvinyl pyrrolidones (PVP), polyvinyl alcohols (PVA), polyethyleneimine (PEI), or combinations thereof. The water can be de-ionized water. In one embodiment, the water soluble polymer 30 is PVP. To make the water soluble polymer 30 with carbonyl or hydroxyl sufficiently dissolved in the water, the solution including the water soluble polymer 30 with carbonyl or hydroxyl can be agitated for several minutes.

In step (S30), the water soluble polymer 30 with carbonyl or hydroxyl can combine with the precious metal ions 22 (such as Au⁺, Ag⁺, Pt⁺ or Pd⁺) in the first mixture to generate a second complex 40. The molar concentration ratio of the precious metal ions 22 and the water soluble polymer 30 with carbonyl or hydroxyl is in a range from about 1:100 to about 1:3. In one embodiment, the molar concentration ratio of the precious metal ions and the PVP is about 1:6.

Referring to FIG. 3, the step (S40) can include the following substeps of:

(S41) providing and purifying a plurality of carbon nanotubes 10;

(S42) functionalizing the carbon nanotubes 10;

(S43) dispersing the functionalized carbon nanotubes 10 in water to from a solution of the carbon nanotubes 10;

(S44) adding the solution of carbon nanotubes 10 to the first mixture to form a second mixture.

In step (S41), the carbon nanotubes 10 can be obtained by any method, such as chemical vapor deposition (CVD), arc discharging, or laser ablation. In one embodiment, the carbon nanotubes 10 can be obtained by the substeps of: providing a substrate; forming a carbon nanotube array on the substrate by CVD; and peeling the carbon nanotube array off the substrate by a mechanical method, thereby achieving a plurality of carbon nanotubes. The carbon nanotubes in the carbon nanotube array are substantially parallel to each other.

The carbon nanotubes 10 can be purified by the substeps of: heating the carbon nanotubes in air flow at about 350° C. for about 2 hours to remove amorphous carbons; soaking the treated carbon nanotubes 10 in about 36% hydrochloric acid for about one day to remove metal catalysts; isolating the carbon nanotubes 10 soaked in the hydrochloric acid; rinsing the isolated carbon nanotubes 10 with de-ionized water; and filtrating the carbon nanotubes 10.

In step (S42), the carbon nanotubes 10 can be treated by an acid with the substeps of: refluxing the carbon nanotubes 10 in nitric acid at about 130° C. for a period of time from about 4 hours to about 48 hours to form a suspension; centrifuging the suspension to form acid solution and carbon nanotube 10 sediment; and rinsing the carbon nanotube 10 sediment with water until the PH of the used water is about 7. The carbon nanotubes 10 can be chemically modified with functional groups such as —COOH, —CHO, and —OH on the walls and end portions thereof after the acid treatment. These functional groups can help carbon nanotubes 10 to be soluble and dispersible in the solvent.

In step (S43), the functionalized carbon nanotubes 10 can be treated by the substeps of: filtrating the carbon nanotubes 10; putting the carbon nanotubes 10 into de-ionized water to obtain a mixture; ultrasonically stirring the mixture; and centrifuging the mixture. The above steps are repeated about 4 to 5 times to obtain a solution of carbon nanotubes 10 and de-ionized water.

In step (S44), the second mixture of de-ionized water, carbon nanotubes 10, precious metal ions 22, and the soluble polymer 30 can be agitated mechanically for about 20 minutes to about 50 minutes at 25° C., about room temperature. In the second mixture, the complex 40 including the precious metals ions 22 and the water soluble polymer 30 with carbonyl or hydroxyl can be entangled with surfaces of the carbon nanotubes 10. Therefore, the precious metal ions 22 are attached to a surface of each of the carbon nanotubes 10 via the water soluble polymer 30.

In step (S50), the water soluble polymer 30 with carbonyl or hydroxyl has good reduction under radiation. The radiation source 50 can be ultraviolet light, laser or γ-ray with a wave length less than 430 nm. On the condition of being radiated, a radical is shifted to the precious metal ions 22, so that the precious metal ions 22 are reduced to precious metal nanoparticles 20. The precious metal nanoparticles 20 are bound to the surfaces of the carbon nanotubes 10 via the water soluble polymers 30 to form the carbon nanotube metal nanoparticles composite 100 which is shown in FIG. 2D.

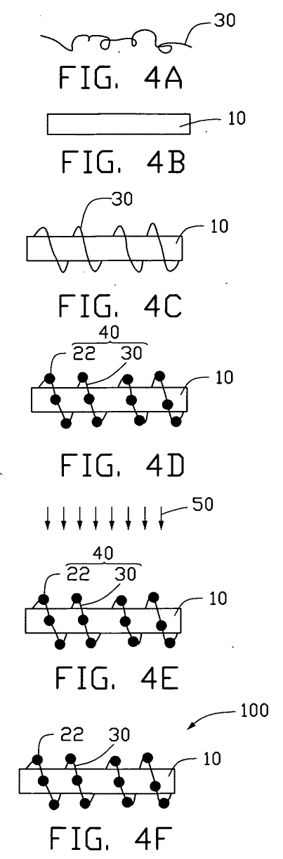

Referring to FIGS. 4A to 4D, another embodiment of a method for making a carbon nanotube metal nanoparticle composite 100 includes:

(S100) providing a water soluble polymer 30 with carbonyl or hydroxyl, dissolving the soluble polymer 30 in water to form a solution of the soluble polymer 30;

(S200) providing a solution containing carbon nanotubes 10, mixing the solution of carbon nanotubes 10 with the solution of the soluble polymer 30 to form a third mixture;

(S300) providing a solution containing precious metal ions 22, mixing the solution of the precious metal ions 22 with the third mixture to form a fourth mixture; and

(S400) irradiating the fourth mixture with a radiation having a wavelength less than 450 nm.

In step (S200), the soluble polymer 30 with carbonyl or hydroxyl can be entangled on a surface of each of the carbon nanotubes 10. The carbon nanotubes 10 combined with the soluble polymer 30 can be efficiently dispersed in the water.

The carbon nanotubes 10 can be can be chemically functionalized, which refers to carbon nanotubes 10 being chemically treated to introduce functional groups on the surface. Chemical treatments include, but are not limited to, oxidation, radical initiation reactions, and Diels-Alder reactions. The functional groups can be any hydrophilic group, such as carboxyl (—COOH), aldehyde group (—CHO), amidogen group (—NH₂), hydroxyl (—OH) or combinations thereof. The carbon nanotubes 10 are soluble in the solvent by the provision of the functional groups.

In step (S300), the precious metal ions can be gold ions (Au⁺), silver ions (Ag⁺), palladium ions (Pd⁺), or platinum ions (Pt⁺). In the present embodiment, the precious metal ions are silver ions. Silver nitrate can be directly mixed with water to obtain the solution with silver ions.

In step (S300), the water soluble polymer 30 with carbonyl or hydroxyl can combine the precious metals ions 22 (such as Au⁺, Ag⁺, Pt⁺ or Pd⁺) in the fourth mixture to generate the complex 40. The molar concentration ratio of the precious metal ions 22 and the water soluble polymer 30 with carbonyl or hydroxyl is in a range from about 1:100 to about 1:3. The precious metal ions 22 can be attached on a surface of each of the carbon nanotubes 10 via the water soluble polymer 30.

In step (S400), the water soluble polymers 30 with carbonyl or hydroxyl have good reduction under radiation. The radiation source 50 can be ultraviolet light, laser or γ-ray with a wave length less than 430 nm. When radiated, a radical is shifted to the precious ions 22, so that the precious ions 22 are reduced to precious metal nanoparticles 20. The precious metal nanoparticles 20 are bound to the surfaces of the carbon nanotubes 10 via the water soluble polymers 30 to form a carbon nanotube metal nanoparticles composite 100.

It is also to be understood that the above description and the claims drawn to a method may include some indication in reference to certain steps. However, the indication used is only to be viewed for identification purposes and not as a suggestion as to an order for the steps.

Finally, it is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A method for making a carbon nanotube metal nanoparticle composite, the method comprising:
(a) providing a solution containing precious metal ions;
(b) providing a solution containing a soluble polymer;
(c) mixing the solution of the precious metal ions with the solution of the soluble polymer to obtain a first mixture;
(d) providing a solution containing carbon nanotubes and mixing the solution of carbon nanotubes with the first mixture to obtain a second mixture; and
(e) irradiating the second mixture with a radiation having a wave length less than 450 nm.

2. The method of claim 1, wherein the precious metal ions are gold ions, silver ions, palladium ions, or platinum ions.

3. The method of claim 1, wherein the soluble polymer has a carbonyl group or a hydroxyl group.

4. The method of claim 3, wherein the soluble polymer is polyvinyl pyrrolidone, polyvinyl alcohol, polyethyleneimine, or combinations thereof.

5. The method of claim 1, wherein the soluble polymer and the precious metal ions are bound with each other to form a complex.

6. The method of claim 5, wherein the complex is entangled on a surface of each of the carbon nanotubes.

7. The method of claim 1, wherein the step (d) comprises the following substeps of:
providing and purifying a plurality of carbon nanotubes;
functionalizing the carbon nanotubes;
dispersing the functionalized carbon nanotubes in water to form a solution of carbon nanotubes; and
adding the solution of carbon nanotubes in the first mixture.

8. The method of claim 1, wherein the radiation is ultraviolet light, laser, or γ-ray.

9. The method of claim 1, wherein a molar concentration ratio of the precious metal ions to the soluble polymer in the first mixture is in a range from about 1:100 to about 1:3.

10. A method for making carbon nanotube metal nanoparticles composite, the method comprising:
(a) providing a solution containing a soluble polymer with a carbonyl group or a hydroxyl group;
(b) providing a solution containing carbon nanotubes and mixing the solution of carbon nanotubes with the solution of the soluble polymer to obtain a third mixture;
(c) providing a solution containing precious metal ions and mixing the solution of the precious metal ions with the third mixture to obtain a fourth mixture; and
(d) irradiating the fourth mixture with radiation having a wave length less than 450 nm.

11. The method of claim 10, wherein the carbon nanotubes are chemically functionalized with a plurality of functional groups.

12. The method of claim 11, wherein the functional group is a hydrophilic group selected from the group consisting of carboxyl, aldehyde group, amidogen, hydroxyl, and combinations thereof.

13. The method of claim 10, wherein the soluble polymer with a carbonyl group or a hydroxyl group is polyvinyl pyrrolidone, polyvinyl alcohol, polyethyleneimine, or combinations thereof.

14. The method of claim 10, wherein the soluble polymer with carbonyl or hydroxyl is entangled on a surface of each of the carbon nanotubes.

15. The method of claim 10, wherein the precious metal ions are gold ions, silver ions, palladium ions, or platinum ions.

16. The method of claim 10, wherein a molar concentration ratio of the precious metal ions to the water soluble polymer with carbonyl or hydroxyl in the fourth mixture is in a range from about 1:100 to about 1:3.

17. The method of claim 10, wherein a radiation source of the radiation is ultraviolet light, laser, or γ-ray.

18. A carbon nanotube metal nanoparticles composite comprising:
a plurality of carbon nanotubes;
a plurality of soluble polymers, wherein at least one soluble polymer is entangled on the surface of each of the carbon nanotubes; and
a plurality of precious metal nanoparticles combined with the carbon nanotubes through the at least one soluble polymer.

19. The carbon nanotube metal nanoparticles composite of claim 18, wherein the precious metal nanoparticles are attached to the at least one soluble polymer.

20. The carbon nanotube metal nanoparticles composite of claim 18, wherein the precious metal nanoparticles are precious metal atoms.
